(19) United States
(12) Patent Application Publication
(10) Pub. No.: US 2009/0027876 A1
(43) Pub. Date: Jan. 29, 2009

(54) Portable Lighting Device

(75) Inventor: Raymond King Wai Yu, Kowloon (HK)

Correspondence Address: INTELLECTUAL PROPERTY LAW GROUP LLP, 12 SOUTH FIRST STREET, SUITE 1205, SAN JOSE, CA, 95113, US

(73) Assignee: QUANTUM LIGHTING PRODUCTS LIMITED, Kowloon (HK)

(21) Appl. No.: 11/828,327

(22) Filed: Jul. 25, 2007

(51) Int. Cl. F21L 4/02

(52) U.S. Cl. 362/184; 362/187

(57) ABSTRACT

A portable lighting device comprising a body with a battery storage, a lamp cap fixed on the body, a circuit board deposited inside the lamp cap, a first LED lamp and a relevant reflection base fixed on the circuit board, an optical diffuser rotatablely connected on the lamp cap as a dispersion lens of the first LED lamp, and a switch fixed on the body to control the on/off of the lighting device. The device has a simple structure and a small size so as to be portable and easily carried; the optical diffuser is rotatable, swiveling to the front of the first LED lamp for close quarters lighting and to the front of the second LED lamp for long-distance lighting. The device includes a clip on the body to attach the device on another object.

### BACKGROUND OF INVENTION

1. Field of Invention

Aspects of the invention relate to a lighting tool, and more particularly, to a portable lighting device.

2. Background

A Light Emitting Diode (LED) is a semiconductor that can transform electric power into visible light. An LED has the advantages of high lighting efficiency a longer life no radiation, and consumption of less power than traditional lighting devices. For these reasons, an LED is suitable for portable lighting devices.

Chinese patent no. 200420110744.0 disclosed an LED electric torch which is configured with a metal barrel body. However, its structure is complex and bulky, thus it is not easy to carry.

There exist small portable lighting devices. However, existing products are, though simple and small, limited in their function: for example, they are suitable only either for long-distance lighting or a short-distance lighting, but not both.

The existing products mentioned above are not admitted to be prior art with respect to the present invention by their mention in this Background Section.

### SUMMARY OF THE INVENTION

The object of the present invention is to provide a multi-functional portable lighting device with a simple structure. The present invention is directed to a portable lighting device that satisfies the needs for the dual function of both long-distance and short-distance lighting, and for a simple and small structure and therefore solves the problems found in devices of complex configurations.

A portable lighting device according to an embodiment of the present invention comprises a body with battery storage, a lamp cap fixed on the body, a circuit board deposited inside the lamp cap, a first LED lamp and a relevant reflect base fixed on the circuit board, an optical diffuser rotatablely connected on the lamp cap to serve as a dispersion lens of the first LED lamp, and a switch fixed on the body to control on/off of the lighting device.

According to various preferred embodiments of the present invention, the device may further comprise one or more of the following features: 1) the battery storage on the body is storage for one AA battery; 2) the device further comprises a clip attached to the body to attach the device to another object; 3) the device further comprises a second LED lamp fixed on the lamp cap and departed with the first LED lamp; 4) the second LED lamp is colored; 5) the optical diffuser can be rotated to the front of the second lamp and to serve as a dispersion lens thereof.

A portable lighting device according to an embodiment of the present invention includes the following utilities: a simple structure; a small size so as to be portable and easily carried; rotatability of the optical diffuser—swiveling to the front of the first LED lamp for close quarters lighting and to the front of the second LED lamp for long-distance lighting.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 and FIG. 2 are perspective views of a portable lighting device according to an embodiment of the present invention.

FIG. 3 is a top view of the portable lighting device of FIG. 1.

FIG. 4 is a sectional view along the A-A line in FIG. 3.

FIG. 5 is a top view of the portable lighting device of FIG. 1.

FIG. 6 is a sectional view along the B-B line in FIG. 5.

FIG. 7 is a top view of the portable lighting device of FIG. 1.

FIG. 8 is a sectional view along the B-B line in FIG. 7.

FIG. 9 is a top view of the portable lighting device of FIG. 1.

FIG. 10 is a sectional view along the D-D line in FIG. 9.

FIG. 11 is a circuit diagram of the portable lighting device of FIG. 1.

### DETAILED DESCRIPTION OF SPECIFIC EMBODIMENTS

The description above and below and the drawings of the present document focus on one or more currently preferred embodiments of the present invention and describe some exemplary optional features and/or alternative embodiments. The description and drawings are for the purpose of illustration and not limitations. Those of ordinary skill in the art would recognize variations, modifications, and alternatives. Such variations, modifications, and alternatives are also within the scope of the present invention.

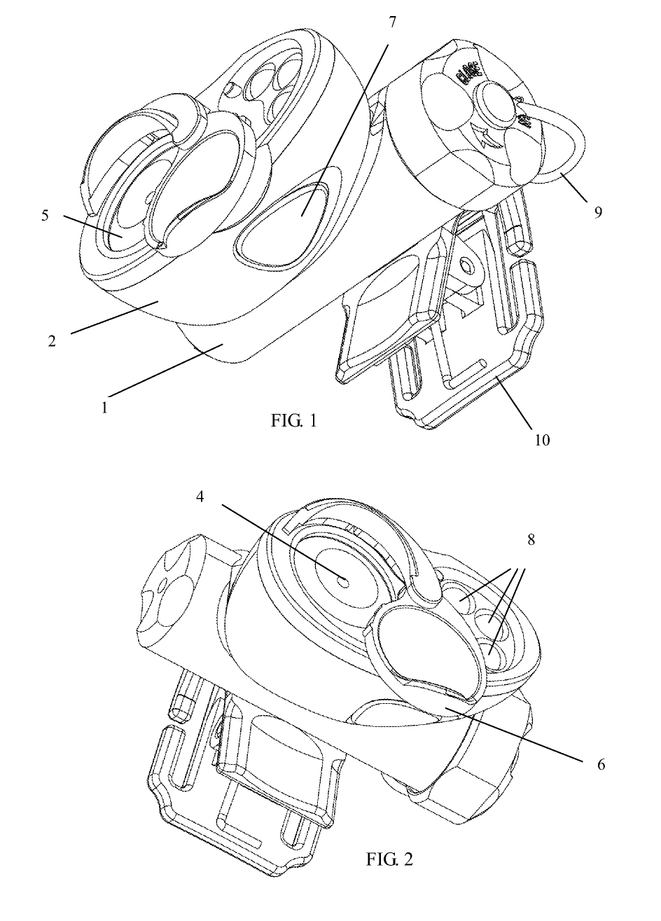

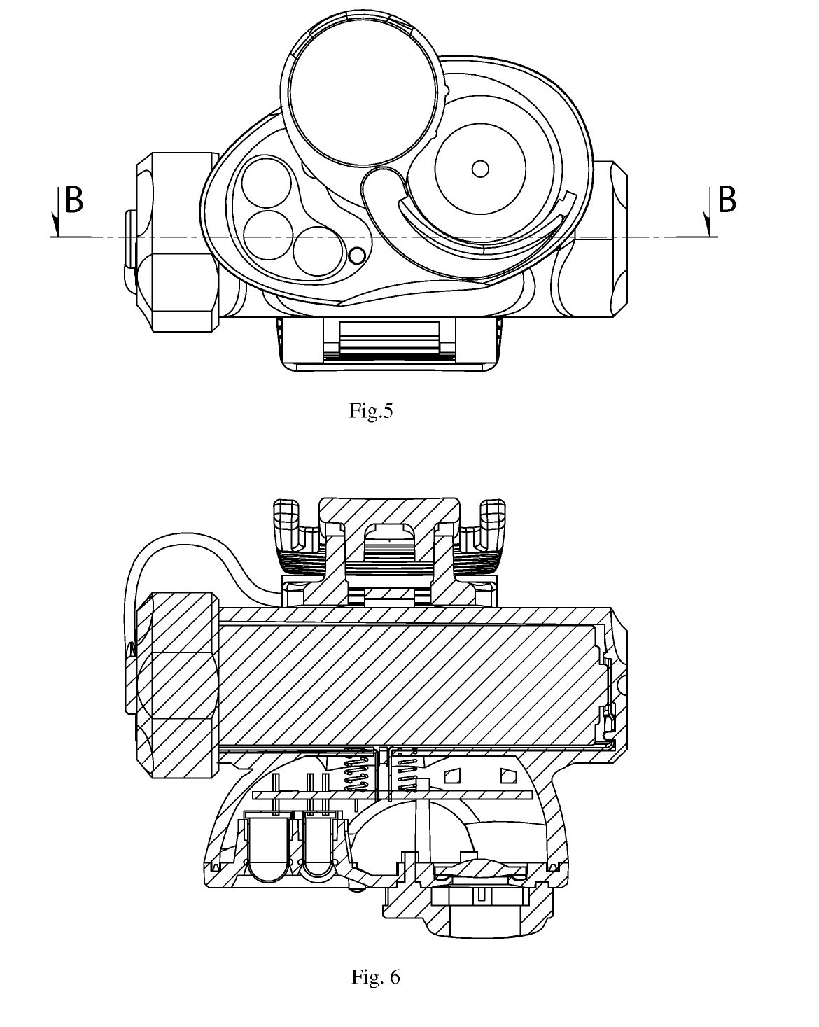

FIG. 1 and FIG. 2 are perspective views of a portable lighting device according to an embodiment of the present invention. The portable lighting device having a body 1 with battery storage, a lamp cap 2 fixed on the body 1, a first LED lamp 4 and a relevant reflection base 5 fixed on a circuit board 3 deposited inside the lamp cap 2 (the circuit board 3 is shown in FIG. 4.), an optical diffuser 6 rotatablely connected on the lamp cap 2 as a dispersion lens of the first LED lamp 4, a switch 7 fixed on the body 1 to control on/off (power) of the lighting device, a second set of LED lamps 8 on the lamp having one more LED lamps, a cap 2 separated from the first LED lamp 4, a lead 9 to conduct electric charge to and from an electrode of the battery, and a clip 10 attached on the body 1.

In an embodiment of the present invention, the first LED lamp 4 is a main lamp, and its power is about 1 watt (W); the second set of LED lamps 8 are assistant lamps. In an embodiment of the present invention, the second set of LED lamps 8 include three 0.5 mm LED lamps in red, blue and green colors. Other colors for the LED may be used.

The optical diffuser 6 is rotatable, therefore, for short-distance lighting, a user can swivel the optical diffuser 6 to the front of the first LED lamp 4. For example, the lighting device is now suitable for reading. For long-distance lighting, the optical diffuser 6 can be swiveled away from the first LED lamp 4, so the light from the LED lamp 4 is directly reflected on the reflection base 5.

The second set of LED lamps 8 are separated from the first LED lamp 4. According to the present embodiment, the second set of LED lamps 8 and the first LED lamp 4 are symmetrical to each other along the connection point of the optical diffuser 6. Therefore, the optical diffuser 6 can rotate both in front of the first LED lamp 4 and the front of the second set of LED lamps 8.

According to an embodiment of the present invention, the battery storage of the body 1 holds one AA size battery in order to be portable and easily carried. Alternatively, other embodiments may allow the battery storage to hold other types of batteries such as but not limited to multiple AA batteries, or one or more AAA batteries.

According to the present embodiment, the clip 10 is attached to the body 1; and the clip may attach the lighting device to another object. Alternatively, other embodiments may use other suitable attachment apparatuses, such as a rubber suction, to attach the light device on the wall or other objects.

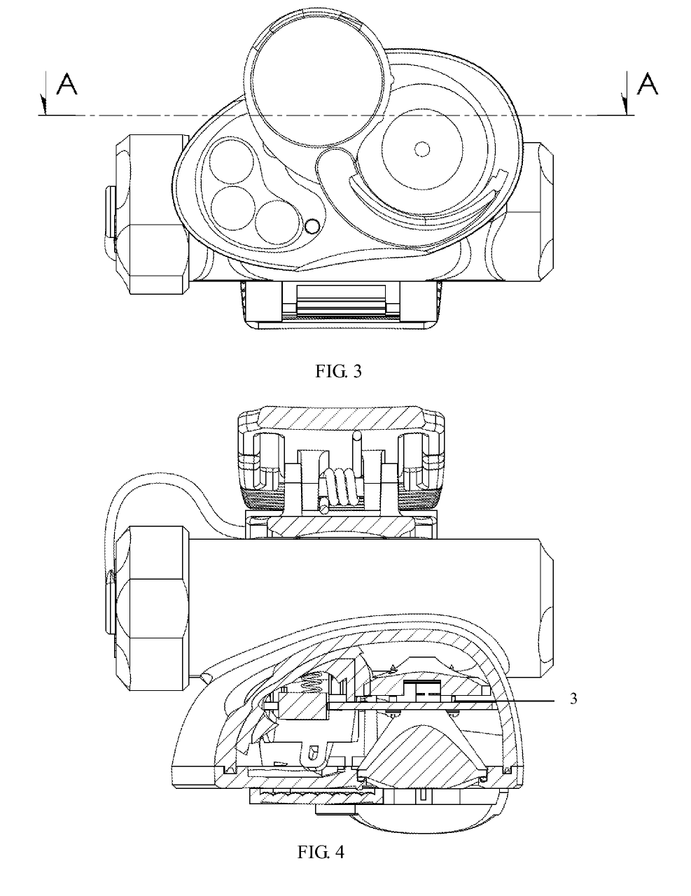

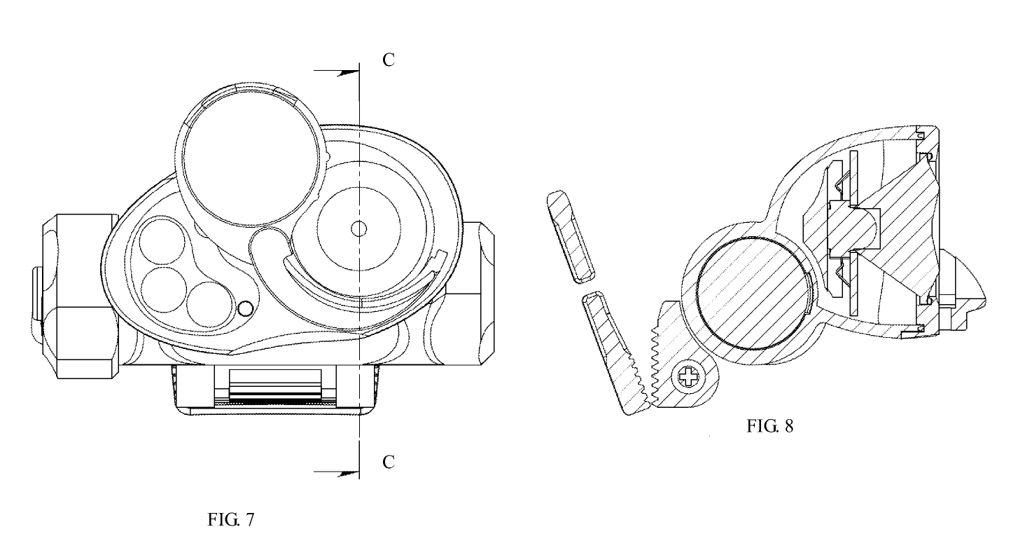

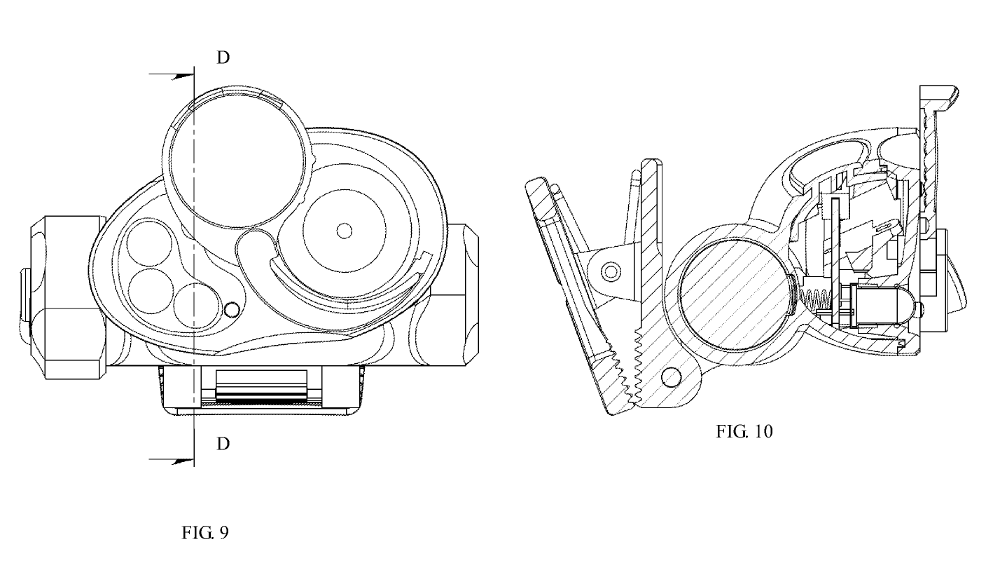

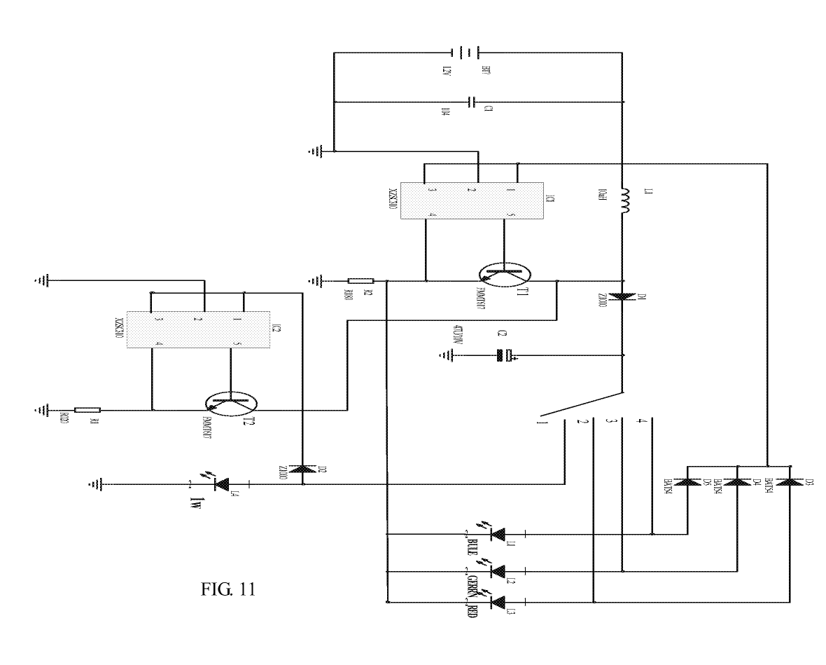

FIGS. 2 to 10 are top views and relevant sectional views of the portable lighting device of FIG. 1 to illustrate the inner structure of the lighting device. More specifically, FIG. 4 is a sectional view along the A-A line in FIG. 3; FIG. 6 is a sectional view along the B-B line in FIG. 5; FIG. 8 is a sectional view along the B-B line in FIG. 7; and FIG. 10 is a sectional view along the D-D line in FIG. 9. FIG. 4 shows the circuit board 3 deposited inside the lamp cap 2. FIG. 6 shows the second set LED lamps 8.

FIG. 11 is a circuit diagram of a portable lighting device of according to an embodiment of the present invention. The circuit may be configured in various ways. For instance, the switch 7 may be configured to control the first LED lamp 4 and second set of LED lamps 8 separately—for example, the switch controls the on/off of the second LED lamps 8 whether the first LED lamp 4 is “on or “off.

Although the present invention has been described in considerable detail with reference to certain preferred version, other versions are possible. Furthermore, the present invention may allow different ways of making transactions. Therefore, the sprit and scope of the appended claims should not be limited to the description of the preferred versions contained therein.

I claim:

1. A portable lighting device comprising:
a body having a battery storage,
a lamp cap fixed on the body,
a circuit board deposited inside the lamp cap,
a first lamp and a reflection base fixed on the circuit board,
an optical diffuser rotatablely connected on the lamp cap as a dispersion lens of the first lamp, and
a switch fixed on the body to control power of the lighting device.

2. The portable lighting device as in claim 1, wherein the battery storage on the body is a storage for one AA battery.

3. The portable lighting device as in claim 1, further comprising a clip attached to the body to attach the device to another object.

4. The portable lighting device as in claim 1, further comprising a second lamp fixed on the lamp cap and separate from the first lamp.

5. The portable lighting device as in claim 2, further comprising a second lamp fixed on the lamp cap and separate from the first lamp.

6. The portable lighting device as in claim 3, further comprising a second lamp fixed on the lamp cap and separate from the first lamp.

7. The portable lighting device as in claim 4, wherein an illumination source of the second lamp has a color.

8. The portable lighting device as in claim 5, wherein an illumination source of the second lamp has a color.

9. The portable lighting device as in claim 6, wherein an illumination source of the second lamp has a color.

10. The portable lighting device as in claim 4, wherein the optical diffuser can be swiveled to the front of the second lamp as a dispersion lens of the second lamp.

11. The portable lighting device as in claim 5, wherein the optical diffuser can be swiveled to the front of the second lamp as a dispersion lens of the second lamp.

12. The portable lighting device as in claim 6, wherein the optical diffuser can be swiveled to the front of the second lamp as a dispersion lens of the second lamp.

13. The portable lighting device as in claim 1, wherein the first lamp includes one or more light emitting diodes as an illumination source.

14. The portable lighting device as in claim 2, wherein the first lamp includes one or more light emitting diodes as an illumination source.

15. The portable lighting device as in claim 3, wherein the first lamp includes one or more light emitting diodes as an illumination source.

16. The portable lighting device as in claim 4, wherein the first lamp and the second lamp each include one or more light emitting diodes as an illumination source.

17. The portable lighting device as in claim 5, wherein the first lamp and the second lamp each include one or more light emitting diodes as an illumination source.

18. The portable lighting device as in claim 6, wherein the first lamp and the second lamp each include one or more light emitting diodes as an illumination source.

19. The portable lighting device as in claim 4, wherein the second lamp is positioned symmetrically with the first lamp along a plane at which the optical diffuser is connected to the lamp cap.
